(19) United States
(12) Patent Application Publication
(10) Pub. No.: US 2008/0180934 A1
(43) Pub. Date: Jul. 31, 2008

(54) LASER LIGHT SOURCE UNIT AND IMAGE FORMING APPARATUS USING THE SAME

(75) Inventors: Michio Oka, Tokyo (JP); Shinichiro Tajiri, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/015,283

(22) Filed: Jan. 16, 2008

(30) Foreign Application Priority Data
Jan. 26, 2007 (JP) 2007-016652

(51) Int. Cl. F21V 13/02

(52) U.S. Cl. 362/19

(57) ABSTRACT

A laser light source unit is provided, including a light source, a wavefront dividing unit, a wavefront synthesizing unit, and a polarization conversion unit. The wavefront dividing unit includes at least a plurality of dividing regions which are capable of dividing a first wavefront of light emitted from the light source to form a plurality of light beams. The wavefront synthesizing unit is configured to synthesize the first wavefront of light divided by the wavefront dividing unit to form a second wavefront and lead the second wavefront to a subject to be illuminated, and the polarization conversion unit is configured to rotate the plane of polarization of a portion of the plurality of light beams. In addition, the polarization conversion unit is provided with at least a plurality of wave plates each having the direction of optical axis different each other.

### CROSS REFERENCES TO RELATED APPLICATIONS

The present application claims priority to Japanese Patent Application JP 2007-16652 filed in the Japanese Patent Office on Jan. 26, 2007, the entire contents of which is being incorporated herein by reference.

### BACKGROUND

The present application generally relates to laser light source units. More particularly, the present application relates to a laser light source unit capable of illuminating a subject with light having improved uniformity in intensity distribution. The present application is also concerned with an image forming apparatus which utilizes the laser light source unit.

A variety of methods have been proposed hitherto for producing one-dimensional or linearly aligned light beams having a uniform intensity distribution through suitable division and superposition process steps of wavefront of laser light. Those methods generally employ a rod lens, facet processed mirror, or lens array.

By way of example including the lens array, FIGS. 1 and 2 are diagrammatical views illustrating the fundamental structure of laser light source units previously known for performing the process of division and superposition of the wavefront of laser light. In the drawings, the x-axis is taken to be in the direction of dividing a wavefront indicated with the allow x, the z-axis in the direction of propagation of the wavefront (optical axis), and the y-axis is drawn perpendicular to the x-, and z-axes. In addition, cross sectional views are each shown along the x-z plane.

Referring to FIGS. 1 and 2, a wavefront dividing unit 77 for dividing a wavefront of laser light includes at least a pair of cylindrical lens arrays 72a and 72b. The cylindrical lens arrays 72a and 72b are placed to be separated by the focal length each other. In addition, a wavefront synthesizing unit 78 may suitably include a condensing lens 73 with one convex lens or other similar element as shown in FIG. 1, and alternatively, a combination of two optical lenses 75 and 76, such as plano-convex lenses as shown in FIG. 2.

Laser light Lo emitted from a light source 71 is divided along the x-axis direction by the wavefront dividing unit 77, superposed and condensed by the wavefront synthesizing unit 78, and subsequently illuminates a predetermined location of the subject 74.

However, in spite of the process of dividing and subsequently superposing the wavefront by the plurality of abovementioned methods including the lens arrays, two neighboring light beams, La and Lb, may still cause interference with each other because of spatial coherence of laser light. As a result, as shown in FIG. 3, fine interference patterns (or fringes) unduly emerge in the focusing region as indicated with the dotted circle D. In FIG. 3, the components and elements similar to those in FIGS. 1 and 2 are shown with identical numerical representations and the repeated description thereof is herewith abbreviated.

The emergence of the fine interference patterns is caused by dividing the wavefront with a distance smaller than the spatial coherence length of laser light, owning to the fact that the divided portions of the wavefront still retain the coherence with each other, thereby forming the interference patterns subsequent to the superposition of the divided portions. On the other hand, a further method may be contemplated of suppressing interference patterns by dividing the wavefront with a distance greater than the spatial coherence length of laser light.

In this method, however, the number of division for the wavefront is difficult to increase as desired, since the coherence length is not small enough, in practice, compared with the diameter of laser beam. As a result, sufficient uniformity in intensity distribution subsequent to the beam superposition is difficult to assure. Further, even in the case where the wavefront is divided with the distance greater than the spatial coherence length of laser light, the coherency still remains, since the spatial coherence is not reduced to zero, in practice.

For example, Japanese Unexamined Patent Application Publications No. 2004-12757 and 2006-49656 disclose a method and device in which a divided wavefront (or wavefront to be divided) is superposed after making an optical path length larger than the temporal coherence length, thereby suppressing the emergence of such fine interference patterns mentioned above.

In the aforementioned devices and methods described in these Patent Publications, a configuration is disclosed in which a wavefront of laser light emitted from a light source is divided, and the thus divided wavefront is subsequently superposed after allowing a portion of the divided wavefront to pass through an optical path difference generating member to thereby make the optical path length of the portion larger than the temporal coherence length.

According to the foregoing configuration, however, the temporal coherence length of laser light is frequently of the order of several centimeters, in practice. Since a sufficient space may be required corresponding to the length along the optical path for the path difference generating member, the configuration of the apparatus may not be preferable for reducing in size of the apparatus.

In addition, when laser beams are not sufficiently collimated, stray light may result from the light reflected by side faces of the path difference generating member. Still in addition, since the optical path length generally has a difference between the two beams paths, which are the one with the path difference generating member and the other without the member, the efficiency in superposing the optical paths is not sufficiently large. As a result, the light utilization efficiency may decrease in such a configuration.

Particularly, in the case where the laser light source is incorporated into an image forming apparatus, the stray light and the reduced light utilization efficiency may not be preferable for achieving satisfactory image qualities.

That is, in the image forming apparatus for performing scan-projection of images on a display screen, for example, the light source is formed as a one-dimensional light source by suitably including an array laser of linearly arranged laser elements, the light emitted from the source is illuminated with predetermined intensity distribution onto a one-dimensional light modulation unit to produce one-dimensionally modulated light (i.e., light image), and the light image is subsequently subjected to projection display on a display screen. In the image forming apparatus mentioned above, satisfactory image qualities may not be obtained due to the stray light and reduced light utilization efficiency.

On the other hand, a further method is contemplated of reducing interference effects by treating neighboring two optical paths as a pair in divided wavefront, by rotating the plane of polarization of the first optical path of the pair approximately by 90°, thereby reducing the interference between the optical paths.

In this case, with the system construction for dividing the laser light by a cylindrical lens array, for example, to form a plurality of light beams, and for allowing every other light beam among the plurality of light beams to pass through ½-wave plate, the emergence of interference patterns through superposition at the focal position can be suppressed because of the 90° difference in the direction of the plane of polarization between two neighboring light beams.

In addition, if the pitch of dividing the laser light is adopted in this case to be approximately one half of the spatial coherence length, it is considered that interference is suppressed to some extent between every other beam. However, since slight coherency still remains beyond the regions exceeding the spatial coherence length even after adopting the pitch of dividing the laser light as approximately one half of the spatial coherence length, slight interference effects may occur between every other beam. As a result, there is a possibility of emerging the interference patterns as large as about several percent.

In contrast to the interference pattern between neighboring light beams, which has a fundamental period of dividing the light wavefront (e.g., the pitch of lens cell in the cylindrical lens array), the interference pattern between every other beams have the period of twice the fundamental one, which causes finer interference patterns on the subject to be illuminated.

In the case where the laser light source is used as the source of the above-mentioned image forming apparatus in the presence of such finer interference patterns, since the illumination onto the light modulation unit becomes non-uniform, the uniformity of image qualities may be deteriorated. Also, in the case where such laser light source is used as the light source of a laser irradiation apparatus utilized for annealing polycrystalline silicon, for example, during fabrication process steps of thin film transistor (TFT), there may exist a possible drawback of reducing manufacturing yield which is caused by the non-uniformity in the distribution of the laser light intensity.

Therefore, it is highly desirable to prevent the interference patterns generated by light beams neighboring each other, which have not only the fundamental dividing period but the twofold or more dividing period, as well.

### SUMMARY

An embodiment may suppress the interference resulted from light beams neighboring each other and having the fundamental dividing period, and prevent the emergence of interference patterns generated by the light beams having the twofold or more dividing period, both in the course of dividing and subsequently superposing laser light from a light source to thereby attain sufficient uniformity in intensity distribution.

An embodiment of the present application may further prevent the degradation in uniformity of image qualities formed by an image forming apparatus by suppressing interference patterns generated by a laser light source incorporated into the image forming apparatus.

According to an embodiment, a laser light source unit includes a light source, a wavefront dividing unit, a wavefront synthesizing unit, and a polarization conversion unit.

The wavefront dividing unit includes at least a plurality of dividing regions which are capable of dividing a first wavefront of light emitted from the light source to form a plurality of light beams. The wavefront synthesizing unit is configured to synthesize the first wavefront of light divided by the wavefront dividing unit to form a second wavefront and lead the second wavefront to a subject to be illuminated. The polarization conversion unit is configured to rotate the plane of polarization of a portion of the plurality of light beams, and this unit is provided with at least a plurality of wave plates each having the direction of optical axis different each other.

According to another embodiment, the plurality of wave plates, which are included in the polarization conversion unit, are provided with first and second wave plates, in which the first wave plate is capable of rotating the plane of light polarization approximately by 90 degrees in negative sense, while the second wave plate is capable of rotating the plane approximately by 90 degrees in positive sense (i.e., approximately by 270 degrees).

According to yet another embodiment, the first and second wave plates included in the polarization conversion unit are alternately provided respectively facing to every other dividing region of the plurality of dividing regions included in the wavefront dividing unit.

According to still another embodiment, there is provided an image forming apparatus including a laser light source unit, a light modulation unit, a projection optical section, and a scanning optics unit.

As the laser light source unit described herein, the abovementioned laser light source unit is suitably utilized, which includes the light source, the wavefront dividing unit, the wavefront synthesizing unit, and the polarization conversion unit.

As described above, the laser light source unit and the image forming apparatus are configured for a portion of the plurality of light beams, which are divided by the wavefront dividing unit in the laser light source unit, to pass through wave plates included in the polarization conversion unit. Accordingly, the interference can be suppressed between light beams having the fundamental period for dividing the laser light, i.e., the beams neighboring each other, which are divided as above by the wavefront dividing unit.

In addition, by means of the wave plates each having the direction of optical axis different each other included in the polarization conversion unit, the amount of phase change can be varied for each of the light beams having the period of twice the fundamental beam dividing period, i.e., the beams corresponding to every other or every third dividing region in the wavefront dividing unit. Therefore, the phase of the light interference between these beams is suitably adjusted, and the interference patterns therefrom can be suppressed in an embodiment, as a result.

Still in addition, in the case where first and second wave plates are provided in the polarization conversion unit, in which the first wave plate is capable of rotating the plane of light polarization approximately by 90 degrees in negative sense, and the second wave plate is capable of rotating the plane approximately by 90 degrees in positive sense; a first phase of the light interference between the beams respectively passing through the first and second wave plates can be made approximately opposite to a second phase of interference between the beams not passing through the wave plate. As a result of the opposite phases, it becomes feasible to suppress the emergence of the interference patterns.

Particularly, in the case where the first wave plate and the second wave plate are provided respectively corresponding to every other region of light dividing regions in the wavefront dividing unit, i.e., every other lens cell of the cylindrical lens array as an example, and when the first and second wave plates are provided alternately; a first phase of the light interference between the beams respectively passing through the pair of the first and second wave plates, which are placed corresponding to every other light dividing region, can be made to be approximately opposite to a second phase of interference between the beams, which pass through the region either between, or outside these wave plates, i.e., which pass none of the wave plates. As a result, it becomes feasible to effectively suppress the emergence of the interference patterns.

Therefore, in the course of dividing and subsequently superposing laser light emitted from a light source to thereby achieve sufficient uniformity in intensity distribution by means of the laser light source unit according to an embodiment, the interference is suppressed for the light beams having the fundamental dividing period, and the emergence of interference patterns is prevented for the light beams having at least the twofold of the dividing period.

In addition, since the interference patterns are suppressed by the abovementioned laser light source unit, it becomes feasible for the image forming unit incorporating this laser light source unit to prevent the emergence of the interference patterns generated by light beams not only with the fundamental dividing period but also at least twofold of dividing period. As a result, there obviated with the present image forming unit is the deterioration in uniformity of image qualities otherwise caused by the emergence of interference patterns.

Additional features and advantages are described herein, and will be apparent from, the following Detailed Description and the figures.

### BRIEF DESCRIPTION OF THE FIGURES

FIG. 1 is a schematic view illustrating the fundamental structure of a known laser light source unit;

FIG. 2 is a schematic view illustrating the fundamental structure of a further known laser light source unit;

FIG. 3 a schematic view illustrating a known laser light source unit with fine interference patterns emerged in a focusing region;

FIG. 4 is a drawing diagrammatically illustrating major components included in a laser light source unit according to a first embodiment;

FIG. 5 is a top view illustrating the polarization conversion unit 5 included in the light source 1 according to the first embodiment;

FIG. 6 is a drawing graphically illustrating the direction of polarization axis of the wave plate;

FIG. 7 is a drawing graphically illustrating the change of interference terms resulted from the light source unit according to the first embodiment;

FIG. 8 is a top view illustrating the polarization conversion unit included in the light source of a comparative example;

FIG. 9 is a drawing graphically illustrating the change of interference terms resulted from the light source of the comparative example;

FIGS. 10A, 10B, and 10C, each illustrate the patterns of light beam interference generated by the wavefront dividing unit including dividing regions of cylindrical lens array, with respect to fundamental, twofold, and threefold period, respectively;

FIGS. 10D, 10E, and 10F, each illustrate the relation between the intensity change of the interference pattern with respect to the surface position on the subject corresponding to FIGS. 10A, 10B, and 10C, respectively;

FIG. 11 is a top view illustrating the polarization conversion unit included in the light source according to a second embodiment;

FIG. 12 is a drawing diagrammatically illustrating major components included in a further laser light source unit incorporating the polarization conversion unit of FIG. 11 according to the second embodiment;

FIG. 13 is a top view illustrating the polarization conversion unit included in the light source unit according to a third embodiment;

FIG. 14 is a drawing diagrammatically illustrating major components included in a further laser light source unit incorporating the polarization conversion unit of FIG. 13 according to the third embodiment;

FIG. 15 is a perspective view illustrating the image forming apparatus according to a fourth embodiment;

FIG. 16 is a perspective view diagrammatically illustrating major components of a light modulation element included in the one-dimensional light modulation section according to the fourth embodiment;

FIG. 17 is a sectional view diagrammatically illustrating major components of the ordinary type light modulation element according to the fourth embodiment; and

FIG. 18 is a sectional view diagrammatically illustrating major components of the blaze type light modulation element according to the fourth embodiment.

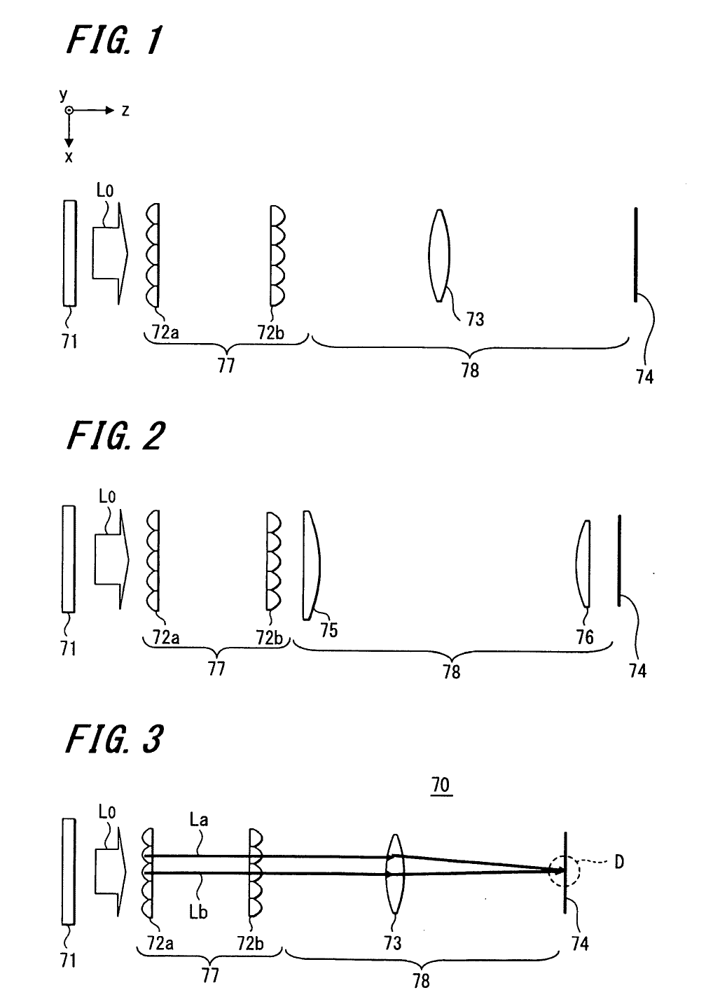

### DETAILED DESCRIPTION

Referring now to the drawings and shown by way of examples according to an embodiment, laser light source units for achieve improved uniformity in intensity distribution of laser light and image forming apparatuses incorporating the laser light source units for obviating a deterioration in uniformity of image qualities are provided.

### FIRST EMBODIMENT

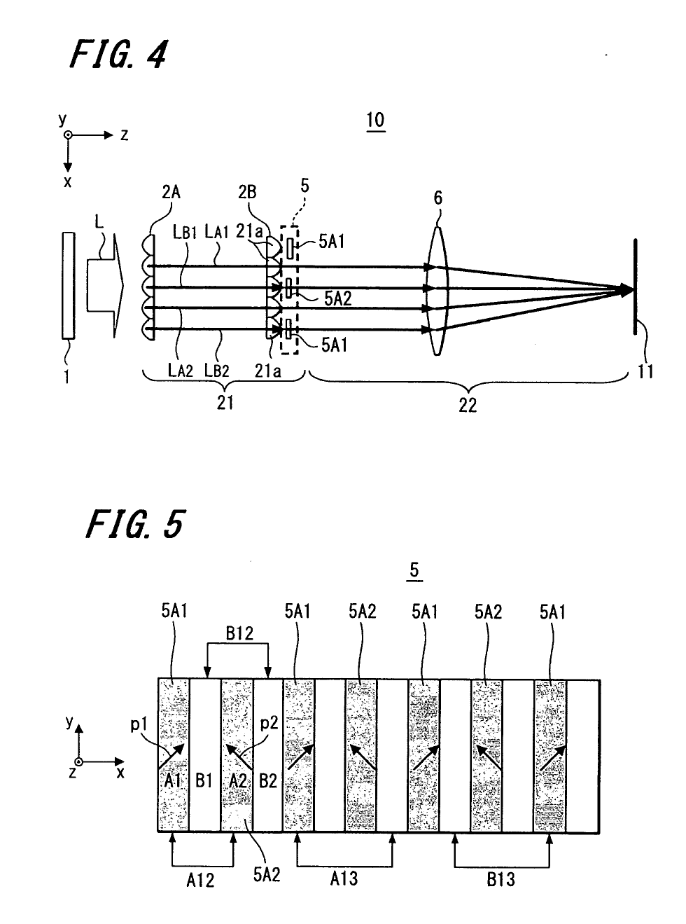

FIG. 4 is a drawing diagrammatically illustrating major components included in a laser light source unit according to a first embodiment.

Referring to FIG. 4, a laser light source unit 10 of the embodiment is shown with a frame of reference defined by three mutually perpendicular axes; x, z, and y. The x-axis is drawn in the direction of dividing wavefront of laser light, the z-axis in the direction of propagation of the wavefront (optical axis) perpendicular to the x-axis, and the y-axis is drawn perpendicular to the other two.

Laser light L emitted from a light source 1 is herein assumed to have a multi-transversal mode elongated in the x-axis direction. The light source 1 may include, for example, a laser array having a plurality of linearly aligned semiconductor laser elements or a bar laser having semiconductor laser elements assembled integrally.

The light source 1 may alternatively include a light source configured to emit a one-dimensional emission such as either (1) a solid-state laser emission generated by one-dimensional multi-transversal mode oscillation or (2) an emission generated from the solid-state laser emission by wavelength conversion using non-linear optical elements which are provided in either the exterior or interior of laser resonator of the solid-state laser. Also shown for convenience in FIG. 4 is a subject 11 to be illuminated.

The laser light source unit 10 includes at least, for example, a pair of cylindrical lens arrays 2A and 2B as a wavefront dividing unit 21, and a condensing lens unit 6 having a convex lens as a wavefront synthesizing unit 22, and other optics. For purposes of clarity, the drawing of the convex lens in the y-direction is abbreviated in FIG. 4. By means of the pair of cylindrical lens arrays 2A and 2B, and by suitably adjusting the position thereof in the z-direction to be separated by the focal length, the laser light source unit 10 is configured to divide a wavefront in one-dimensional direction (transverse direction) and subsequently superimpose the thus divided wavefront portions to illuminate desired locations.

Further, a variety of other optical elements may additionally be provided between the light source 1 and the cylindrical lens array 2A, such as replication mirrors for purposes of reducing the size of the laser light source unit, and optical delay loops inserted for reducing speckles. Regarding optical system for the wavefront synthesizing unit 22, a couple fundamental forms are known as shown previously in reference to FIGS. 1 and 3, the one includes a convex lens, and the other includes two plano-convex lenses. In the present application, one of the forms or a derivation therefrom may be utilized insofar as the capability is achieved of suitably superimposing divided wavefront portions to illuminate desired locations.

In addition, as exemplified in FIG. 4, a polarization conversion unit 5 is provided for suitably rotating the plane of polarization of neighboring light beams. The polarization conversion unit 5 is provided either just in front of, or right behind one of the cylindrical lens arrays, 2A and 2B, which is placed downstream of the beam propagation. This may be exemplified in FIG. 4 as the unit 5 placed right behind the cylindrical lens array 2B.

By providing the polarization conversion unit 5 either just in front of, or right behind the last optical element along the direction of light propagation (e.g., right behind, as shown in FIG. 4), that is, by providing in the immediate vicinity of the face of light emission edge of the wavefront dividing unit 21, there achieved is the reduction of the generation of undue light scattering in the edge portion and also the stray light generation, which are resulted from a decreased amount of light illuminating the edge portion with decreasing spread of light beams at the location of the dividing unit 21.

In particular, by providing the polarization conversion unit 5 not in front of, but right behind the cylindrical lens array 2B as exemplified just above, a further advantage is offered such as almost no occurrence of undue deviation of magnification and beam positions at the focal point, since almost no change is caused in optical path length in the wavefront dividing unit 21.

Further, the polarization conversion unit 5 in the present application is provided with a plurality of wave plates each having the direction of optical axis different each other. As exemplified in the drawing, the polarization conversion unit 5 is formed with first and second wave plates 5A1 and 5A2, each different in the direction of the optical axis. For example, the polarization conversion unit 5 may be provided to include the first second wave plate 5A1 capable of rotating the plane of light polarization approximately by 90 degrees in negative sense and the second wave plate 5A2 capable of rotating the plane approximately by 90 degrees in the opposite sense.

As shown in the example of FIG. 4, the first and second wave plates 5A1 and 5A2 are sequentially placed facing to dividing regions 21a of the wavefront dividing unit 21 with one dividing region 21a intervening therebetween. Namely, the first and second wave plates 5A1 and 5A2 are placed respectively facing to every other lens cell of the cylindrical lens array 2B, and the wave plates 5A1 and 5A2 are alternately provided as described above.

As the wave plates 5A1 and 5A2 there used are, for example, a wavelength film, a thin film wave plate, a quartz wave plate, a Fresnel rhomb, or other similar elements. In addition, a further structure may alternatively used, in which a polarization conversion element such as the wavelength film is placed partially covering a transparent substrate having no polarization conversion capability.

It may be noted that the construction of the wave plate for the polarization conversion unit 5 is not limited to those described hereinabove, and may be replaced with other suitable units insofar as some of those have the capability of rotating the plane of light polarization by approximately 90 degrees in one direction and others are capable of rotating by approximately 90 degrees in the opposite direction. Although the angles of rotating the plane of light polarization are preferably 90 degrees in one direction and also 90 degrees in the opposite direction (i.e., −90 degrees), relatively slight deviations from the 90 degrees may be allowed having only minor effects on the reduction of beam interference.

In addition, because of relatively small thickness, in general, of the wave plate as the optical element for rotating the plane of light polarization, almost no change is caused in optical path length in the lens cell between before and after placing the wave plate. As a result, almost no undue deviation of magnification and beam positions has occurred at the focal point on the subject 11 to be illuminated.

By means of the configuration mentioned hereinabove of the optical system of the embodiment, the laser light L emitted from the light source 1 is divided by the cylindrical lens arrays, 2A and 2B, of the wavefront dividing unit 21, to thereby form a plurality of light beams or fluxes; transmitted through the polarization conversion unit 5, superimposed by the wavefront synthesizing unit 22 having, for example, the condensing lens unit 6; emitted from the laser light source unit 10; and illuminate a predetermined location on the subject 11 to be illuminated with a predetermined beam shape.

For the present construction, an adjustment may be carried out so that the pitch between the lens cells of the cylindrical lens arrays 2A and 2B to be approximately ½ of the spatial coherence length of the present laser. As a result, undue interference between neighboring light beams is suppressed.

Namely, by suitably rotating the plane of polarization by the polarization conversion unit 5 interposed in the beam path as shown in FIG. 4, the emergence of interference patterns or fringes is effectively suppressed even after superposing the wavefronts of neighboring light beam pairs, LA1 and LB1, and LA2 and LB2, which are each previously divided by the wavefront dividing unit 21. In addition, it is feasible according to the embodiment that interference effect resulted from the superposition of the wavefront is reduced further for light beam pairs, LA1 and LA2, LB1 and LB2, each corresponding to every other lens cell. This effect of interference reduction by the every other beam pairs is described in detail hereinbelow.

FIG. 5 is a top view illustrating the polarization conversion unit 5 included in the light source 1 according to the first embodiment of the embodiment. Referring to FIG. 5, the polarization conversion unit 5 is illustrated herein including dividing regions of the wavefront dividing unit 21. The dividing regions are each made of ½-wave plate, being provided to correspond to every other lens cell of the first and second wave plates, 5A1 and 5A2.

In the drawing of FIG. 5, the x-axis is drawn in the direction of dividing wavefront of laser light, the z-axis in the direction of propagation of the wavefront, and the y-axis is drawn perpendicular to the x-, and z-axes, and the polarization conversion unit 5 is shown herein as a plane view when viewed from the direction of z-axis (optical axis).

The first and second wave plates 5A1 and 5A2 are each provided to have 45°-arrangement with respect to the x-axis as indicated with the arrow p1, and 135°-arrangement as indicated with the arrow p2, respectively, so that the direction of the polarization thereof are rotated by 90° from each other.

Jone's polarization matrices are expressed hereinbelow by Equations, 1 and 2, representing the relationship between the rotation R and phase change C, respectively.

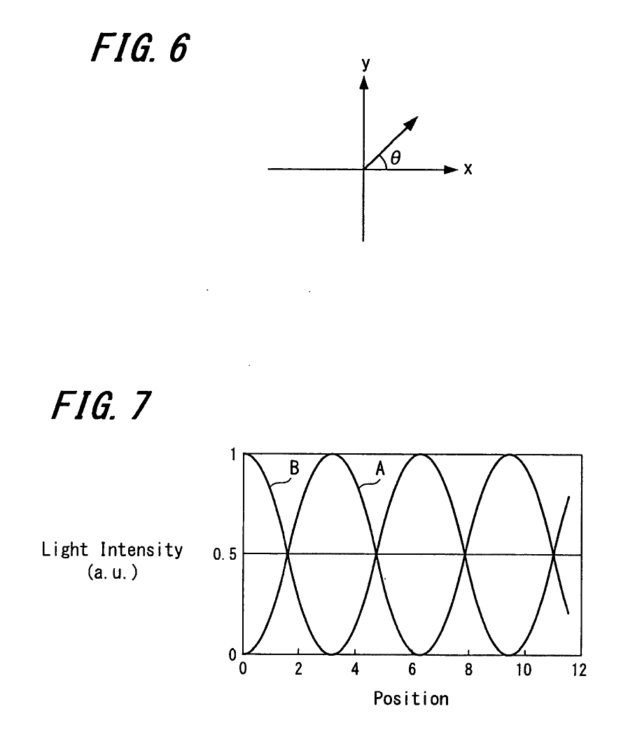

In addition, FIG. 6 graphically illustrates the direction of polarization axis of the wave plate, where the angle θ of rotation is specified by the angle of polarization axis away from x-axis on the x-y plane.

$$\begin{matrix}R ( θ ) = ( \begin{matrix}cos θ & - sin θ \\ sin θ & cos θ\end{matrix} ) & ( 1 ) \\ C ( φ ) = ( \begin{matrix}exp ( - iφ ) & 0 \\ 0 & 1\end{matrix} ) & ( 2 )\end{matrix}$$

Since the polarization matrix m is defined as

m=R(θ)×C(φ)×R(−θ),

the polarization matrix m and polarization E-components of the emitted light beam, E₁′ and E₂′ in the case of θ=45°, are expressed by Equations, 4 and 5, for incident polarized beams such as expressed by Equation (3).

$$\begin{matrix}{E}_{1} = ( \begin{matrix}1 \\ 0\end{matrix} ) , {E}_{2} = ( \begin{matrix}0 \\ 1\end{matrix} ) & ( 3 ) \\ \begin{matrix}m = R ( \frac{π}{4} ) \times C ( π ) \times R ( - \frac{π}{4} ) \\ = ( \begin{matrix}0 & - 1 \\ - 1 & 0\end{matrix} )\end{matrix} & ( 4 ) \\ {E}_{1}^{′} = ( \begin{matrix}0 \\ - 1\end{matrix} ) , {E}_{2}^{′} = ( \begin{matrix}- 1 \\ 0\end{matrix} ) & ( 5 )\end{matrix}$$

In addition, the polarization matrix m and the polarization E-components, E₁′ and E₂′ in the case of θ=135°, are expressed by Equations 6 and 7.

$$\begin{matrix}\begin{matrix}m = R ( \frac{3 π}{4} ) \times C ( π ) \times R ( - \frac{3 π}{4} ) \\ = ( \begin{matrix}0 & 1 \\ 1 & 0\end{matrix} )\end{matrix} & ( 6 ) \\ {E}_{1}^{′} = ( \begin{matrix}0 \\ 1\end{matrix} ) , {E}_{2}^{′} = ( \begin{matrix}1 \\ 0\end{matrix} ) & ( 7 )\end{matrix}$$

That is, the present results show that the sign of the polarization components are reversed from the 0=45° (θ1) alignment to the θ=135° (θ2) alignment, thereby indicating the phase of polarization rotated by 180°. Namely, a phase difference of 180° is resulted from passing the light through the wave plate in the above mentioned arrangement. That is, for two beams of light, the one beam passing through ½-wave plate which is aligned for the optical axis thereof aligned to be 45° so as to rotate approximately by 90° the plane of polarization of the emitted light beam, and the other resulted from passing it through ½-wave plate which is aligned to be 135° so as to rotate the plane of polarization approximately by 90°, thereby 180° phase difference results.

In addition, since the intensity of light beams emitted from different dividing regions, i.e., lens cells in the present case, is expressed by

|E+E′|²=|E|²+|E′|²+2E×E′,

and its interference term is also expressed by E×E′, which indicates that the phase of interference pattern is shifted by 180° by comparing the two interference terms, the one term for the light beams each having the phase of the same sign and the other for the beams each having the phase inverted each other by 180°.

In the polarization conversion unit 5 shown in FIG. 5, therefore, the phase of the interference term is opposite in sign each other for first and second light beams from every other regions, A1 and A2, passing through the first and second wave plates 5A1 and 5A2 respectively, (that is, the sign of the interference term is opposite, which is formed between the light beams passing through the regions indicated with the arrow A12); while the phase of the interference term is the same in sign each other for the beams from regions, B1 and B2, both not passing through the ½-wave plate (that is, the sign is the same for the beams passing through the regions indicated with the arrow B12).

Namely, in the case where the orientation of ½-wave plate is arranged in the alternate manner as abovementioned, the phase of interference patterns are all opposite in sign for the beams each passing through the every other dividing region provided with the wave plate. By contrast, the phase is all the same in sign each other for the beams from every other region which is not passing through the wave plate.

In reference to FIG. 7, the phase of the interference term A, which is formed for the light beams of the opposite sign each passing through the first and second wave plates 5A1 and 5A2 is inverted with respect to the phase of the interference term B, which is formed for the beams each having the same sign and without passing through the wave plate. As a result, the emergence of interference pattern is suppressed after averaging out through the superposition of these interference terms.

Namely, by utilizing the abovementioned arrangement, the emergence of overall interference pattern is prevented as a result of interaction between two interference patterns, the one being generated by the beams passing through the region A1-A2 shown in FIG. 5 and the other by the beams passing through the region B1-B2.

It may be noted in the example shown in FIG. 4 that the portion of optical path of dividing regions, which is neighboring to the polarization conversion unit 5, does not contribute to generate the interference pattern because of the difference in the orientation of the plane of polarization, and that the interference pattern is not generated for the beams passing through every third dividing regions as indicated with the arrows, A13 and B13, also because of different orientation of the plane of polarization.

Therefore, in the polarization conversion unit 5 in the embodiment shown in FIG. 5, the effect of suppressing the interference pattern is achieved for the light source of relatively large spatial coherence length. For example, even in the case where the spatial coherence spreads out to every third dividing region in the wavefront dividing unit 21 and the interference among these regions is difficult to be neglected, the emergence of interference pattern is sufficiently prevented.

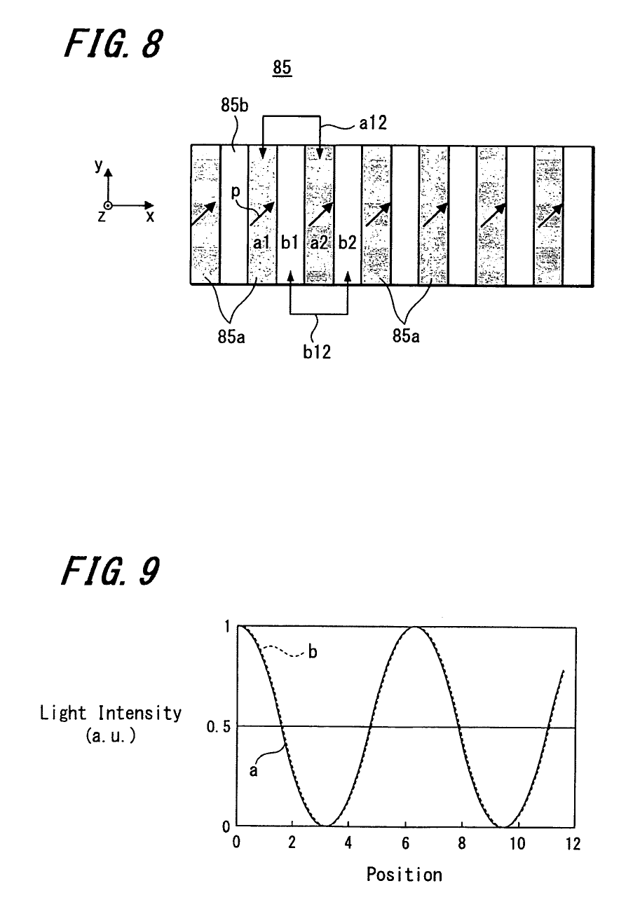

In contrast to the abovementioned construction, a comparative example is described hereinbelow with a polarization conversion unit 85 in reference to FIG. 8. In this comparative example, wave plates 85a each having ½-wave plate, for example, are provided facing to every other dividing region of wavefront dividing unit in a polarization conversion unit 85 (i.e., every other lens cells in the case of cylindrical lens array). In this case, the optical axis of each wave plate 85a is aligned at 45° in order to rotate the polarization of the light beams passing through neighboring dividing regions alternately by 90°.

Referring to FIG. 8, in similar manner to the axis system of FIG. 5, the x-axis is drawn in the direction of dividing wavefront of laser light, the z-axis in the direction of propagation of the wavefront, and the y-axis is drawn perpendicular to the x-, and z-axes. For the light beams, a1 and a2, each passing through the wave plates 85a, and the beams, b1 and b2, without passing through the wave plate; a slight interference unduly emerges between the beams, for example, a1 and a2, which are indicated with the arrow a12, or b1 and b2, indicated with the arrow b12.

FIG. 9 illustrates diagrammatically the resultant interference term in the comparative example of FIG. 8 for the arrangement, in which same wave plates 85a are provided each aligned at 45° corresponding to every other dividing region of wavefront dividing unit. Referring to FIG. 9, graphical plots are shown regarding the changes of the interference term, the one shown with a solid line a for the light beams passing through the regions, a1 and a2, and the other shown with a broken line b for the beams, respectively. In the plots, the solid lines a and b are the same in phase, indicating the emergence of the interference pattern.

In contrast, since the wave plate are provided, in the first embodiment described earlier, including wave plates in the polarization conversion unit, of which optical axes are aligned alternately in different direction, the phase of the interference term is rendered opposite in sign each other for, and the interference pattern from every other beam cancel out each other, as a result.

In the first embodiment mentioned hereinabove, there illustrated is the case where the emergence of interference pattern is effectively prevented by phase inversion of the light beams each corresponding to every other dividing region of wavefront dividing unit. In practice, however, an ideal prevention of the interference pattern is difficult to achieve and slight interference effects may remain, as a result of possible production errors of ½-wave plates, alignment errors of optical axes, and/or uneven distribution of light intensity.

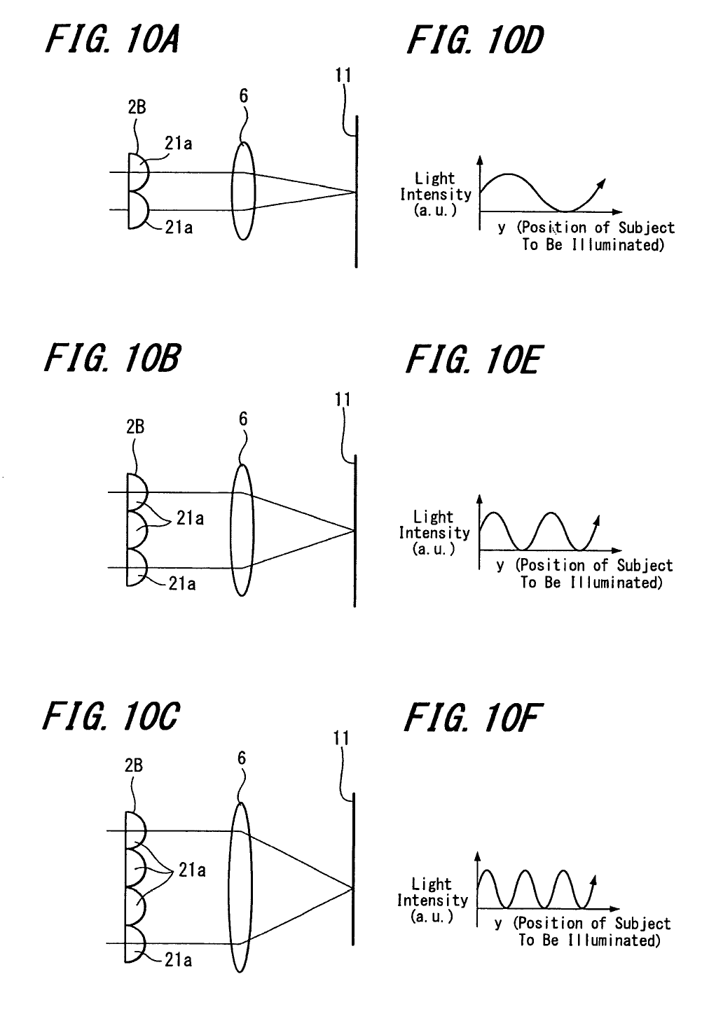

Referring to FIGS. 10A, 10B, and 10C, the patterns of light beam interference are shown, which are generated by the wavefront dividing unit including dividing regions 21a of cylindrical lens array 2A, with respect to fundamental, twofold, and threefold periods, respectively. In addition, the location of the thus generated interference pattern is shown in FIGS. 10D, 10E, and 10F, with respect to the surface of the subject to be illuminated corresponding to FIGS. 10A, 10B, and 10C, respectively, where the graphical plots are made regarding the location y on the subject to be illuminated, horizontally, versus the intensity of light interference, vertically.

Comparing with the interference pattern for fundamental period, shown in FIG. 10D, the spatial frequency is two times as shown in FIG. 10E for the twofold period, while three times for the threefold period as in FIG. 10F.

Accordingly, the interference between the light beams, each having twofold, or threefold period, generates higher spatial frequencies than the light beams with the fundamental period, and finer interference patterns are generated.

Depending on the usage of light beams emitted from laser source, fine interference patterns with the higher spatial frequency may be of more use than the low frequency interference patterns.

By way of example, in image forming apparatuses which are described later on, it may be contemplated to reduce the effect from interference patterns by, for example, suitably adjusting input signals by means of a light modulation unit. In such a case, it may be increasingly difficult to make adjustments for interference patterns with finer spatial periods. In such a case, it may be useful to arrange light beams to either eliminate in principle, or hardly cause the emergence of interference more efficiently for the light beams with twofold and threefold period, than the beams with fundamental period.

In the next place, a further embodiment is illustrated to efficiently suppress the emergence of interference between the light beams having twofold and threefold periods.

### SECOND EMBODIMENT

FIG. 11 is a top view diagrammatically illustrating a polarization conversion unit included in a light source according to a second embodiment of the embodiment. The components and units similar to those in FIG. 5 are shown with identical numerical representations and the repeated description thereof is herewith abbreviated.

Referring to FIG. 11, the polarization conversion unit 5 includes first and second wave plates 5A1 and 5A2. A ½-wave plate is used as the first wave plate 5A1 for rotating the plane of polarization of the emitted light beam approximately by 90°, while another ½-wave plate is used as the second wave plate 5A2 for rotating the plane of polarization of the emitted beam toward the opposite direction approximately by 90°, i.e., approximately by 270°. Namely, these polarization directions are achieved by aligning optical axes of the first and second wave plates 5A1 and 5A2 are aligned to have the angels of 45° and 135° with respect to the x-axis, respectively.

Further, in the present embodiment, a first pair of the first and second wave plates 5A1 and 5A2 is provided facing two neighboring dividing regions of wavefront dividing unit such as two neighboring first and second lens cells in a cylindrical lens array, and another similar pair is provided in every third manner, i.e., facing the fifth and sixth dividing regions, with two dividing regions interposed therebetween. Further, the arrangement of the pairs is repeated continuously in that order.

That is, the arrangement is formed in this case by repeating the sequence of the first wave plate 5A1, the second wave plate 5A2, a first non-polarization conversion region (without wave plate), a second non-polarization conversion region (without wave plate) and so forth along the x-axis direction, each corresponding to the dividing regions or lens cells. Alternatively, a further arrangement may also be formed by repeating the sequence of the second wave plate 5A2, the first wave plate 5A1, the first non-polarization conversion region, the second non-polarization conversion region and the like.

In the present arrangement, a pair of light beams each passing through every other region includes the one beam passing through one of the first and second wave plates 5A1 and 5A2 and the other passing through the non-polarization conversion region. As a result, interference is prevented between the pair of light beams, since the direction of polarization is orthogonal to each other for these beams. That is, there results no emergence of the interference of the twofold period. In addition, in the manner similar to the first embodiment, since the phase of the interference term is opposite in sign, which is resulted from the light beams passing through neighboring regions, the interference pattern counteracts with each other.

Namely, the interference term resulted from the first and second beams respectively passing through the first and second wave plates 5A1 and 5A2 i.e., the regions indicated with the arrow AA′, is opposite in sign each other; while the term is the same in sign, which is resulted from the beams each passing through the regions indicated with the arrow BB′, in which the arrow BB′ does not point to the first and second wave plates, 5A1 and 5A2. Therefore, the interference between the beams passing through neighboring paths cancels out by the phase inversion.

Similarly, two interference terms resulted from light beams passing through every fourth region cancel out each other by the phase inversion, the one term being resulted from the beams each passing through the regions indicated with the arrow CC′, and the other by the beams through the regions indicated with the arrow DD′. It becomes feasible with the arrangements according to the second embodiment to eliminate the interference pattern from the beams from the fundamental, to twofold, and up to threefold period.

Particularly in the present arrangement, since no interference pattern emerges, in principle, between the light beams in the twofold period, this provides advantages of reliably preventing the emergence of interference patterns with finer spatial periods.

It is needles to add that the similar result is alternatively obtained by the arrangement with a reversed order of the first and second wave plates 5A1 and 5A2 that is, with the sequence in the x-axis direction including the second wave plate 5A2, first wave plate 5A1, first non-polarization conversion region, second non-polarization conversion region and the like.

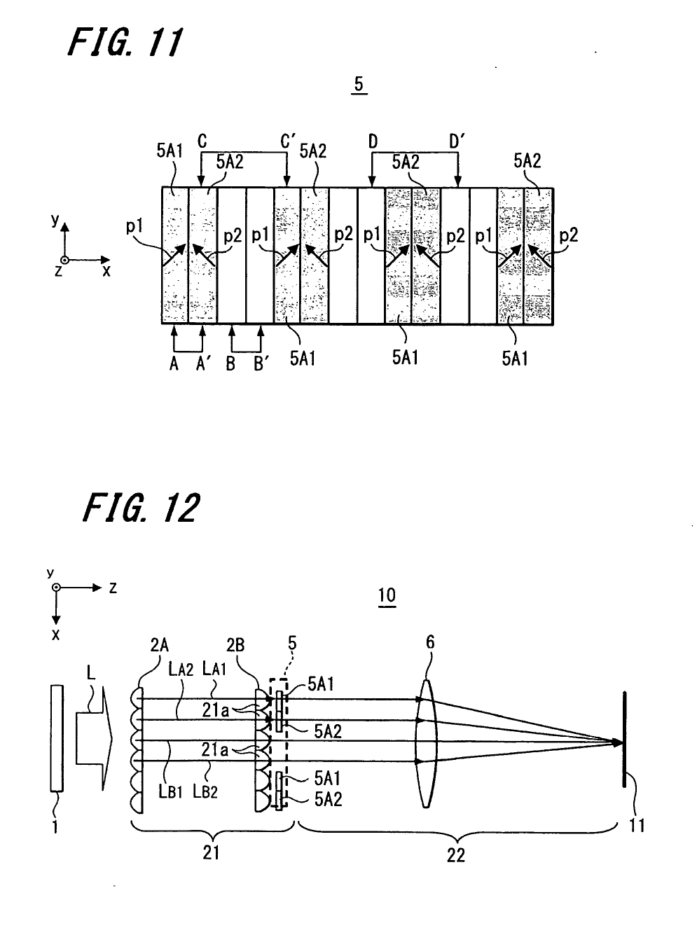

FIG. 12 is a drawing diagrammatically illustrating major components included in a further laser light source unit of the second embodiment incorporating the polarization conversion unit 5 of FIG. 11. The components and units included in FIG. 12 similar to those in FIG. 4 are shown with identical numerical representations and the repeated description thereof is herewith abbreviated.

As described hereinabove, the interference patterns are suppressed, which are respectively generated by the light beams LA1 and LA2 having the fundamental period; the beams, LA1 and LB1, having the twofold period; and the beams LA1 and LB2 having the threefold period.

### THIRD EMBODIMENT

Although it is feasible to eliminate the interference pattern from the light beams having the fundamental, twofold, and threefold period according to the first and second embodiments described hereinabove, an interference pattern, which is generated by the light beams each passing through every fifth region, is difficult to be eliminated. In the next place, a further configuration is illustrated to preferentially eliminate the emergence of interference between the beams passing through every fifth region.

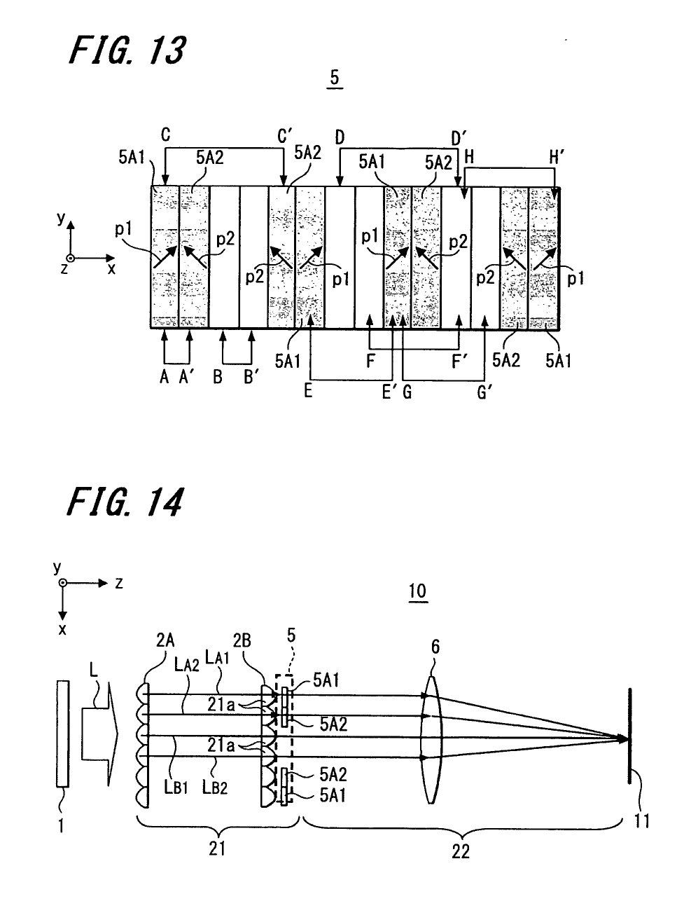

FIG. 13 is a top view diagrammatically illustrating a polarization conversion unit according to a third embodiment. The components and units similar to those in FIGS. 8 and 11 are shown with identical numerical representations and the repeated description thereof is herewith abbreviated.

Referring to FIG. 13, the polarization conversion unit 5 includes in this case also first and second wave plates, 5A1 and 5A2. A ½-wave plate is used as the first wave plate 5A1 for rotating the plane of polarization of the emitted light beam approximately by 90° clockwise, i.e., toward the negative direction in the drawing, while another ½-wave plate is used as the second wave plate 5A2 for rotating the plane of polarization toward the opposite direction approximately by 90°. Namely, these polarization directions are achieved by aligning optical axes of the first and second wave plates 5A1 and 5A2 to have the angels of 45° and 135° with respect to the x-axis, respectively.

A first pair of the first and second wave plates 5A1 and 5A2 is provided facing dividing regions of wavefront dividing unit such as two neighboring first and second lens cells in a cylindrical lens array, and a second similar pair is provided in every third manner, i.e., facing the fifth and sixth dividing regions, with two dividing regions interposed therebetween.

Further, the order of the wave plate in the second reversed such as 5A2 and 5A1, in place of the previous order of 5A1 and 5A2. That is, the arrangement is formed in this case by providing the regions, which face dividing regions of wavefront dividing unit such as lens cells in a cylindrical lens array, to form the sequence of the first wave plate 5A1, the second wave plate 5A2, a first non-polarization conversion region (without wave plate), a second non-polarization conversion region (without wave plate), the second wave plate 5A2, the first wave plate 5A1, a third non-polarization conversion region, a fourth non-polarization conversion region and the like, repeated along the x-axis direction.

FIG. 14 is a drawing diagrammatically illustrating major components included in a further laser light source unit of the third embodiment incorporating the polarization conversion unit 5 of FIG. 13. The components and units included in FIG. 14 similar to those in FIGS. 4 and 12 are shown with identical numerical representations and the repeated description thereof is herewith abbreviated.

In the present arrangement in similar manner to the second embodiment, a pair of light beams each passing through every other region includes a first beam passing through one of the first and second wave plates 5A1 and 5A2 and a second beam passing through the non-polarization conversion region. As a result, the interference is prevented between the pair of beams, since the direction of polarization is orthogonal to each other. That is, there results no emergence of the interference of the twofold period.

Similarly, since the phase of the interference term is opposite in sign, which is resulted from the beams passing through neighboring regions, the interference pattern counteract with each other. Namely, the interference term resulted from the beams each passing through the first and second wave plates 5A1 and 5A2 i.e., the regions indicated with the arrow AA′, is opposite in sign each other. As a result, the interference between the beams passing through neighboring paths cancels out by the phase inversion.

Further, two interference terms resulted from the beams passing through every fifth region cancel out each other by the phase inversion, the one term resulted from the beams each passing through the regions indicated with the arrow CC′ and the other from the beams through the regions indicated with the arrow DD′. Therefore, it becomes feasible with the arrangements of the third embodiment to eliminate the interference pattern from the light beams from the fundamental, twofold, threefold, and fourfold period.

Regarding the threefold period for the first interference term resulted from the two light beams shown in FIG. 13 each passing through the wave plates 5A1 indicated with the arrow EE′ interposed by two regions, and for the second interference term resulted from the two beams each passing through non-polarization conversion region (without wave plate) indicated with the arrow FF′, it may be noted that the first and second interference terms are the same in sign.

On the other hand, regarding the interference generated by two beams, the one passing through non-polarization conversion region without wave plate, and the other passing through the first wave plate 5A1 (or second wave plate 5A2) provided at the location separated by three regions from the non-polarization conversion region indicated with the arrow GG′ or HH′, this interference is suppressed, since the direction of polarization is orthogonal to each other for the two beams.

According to the third embodiment, therefore, the interference between the light beams each passing through the threefold region can be reduced by half.

Therefore, it becomes feasible with the arrangements according to the third embodiment to eliminate the interference resulted from the light beams of the fundamental, twofold, and fourfold period, and also to reduce by half the interference resulted from the beams of the threefold period. As a result, the present arrangement is particularly advantageous for use incorporated into light sources of image forming apparatuses, for example, in which interference patterns of high frequencies having the fourfold period, i.e., interference patterns with finer spatial periods, are of great significance.

According to the embodiments 1 through 3, by providing either ½-wave plates facing every other dividing region of the wavefront dividing unit, or a pair of ½-wave plates each different in the direction of optical axis facing every third dividing region, it becomes feasible to the interference is suppressed not only for light beams each passing through dividing regions of wavefront dividing unit having the fundamental period, i.e., neighboring dividing regions; but also for the beams each passing through dividing regions of the twofold period, i.e., every other dividing regions.

Even in the case where the spatial coherence of laser light from light source is managed within the neighboring dividing region of wavefront dividing unit i.e., within twice the lens cell pitch in the cylindrical lens array, the emergence of interference pattern has been observed previously to the degree as much as about 10% or greater because of slight undue extension of the coherence length.

In an embodiment, by contrast, the emission of laser beams becomes feasible with improved uniformity in intensity distribution, since interference pattern, which is generated by laser beams each passing through the regions of the period of twofold or higher, is substantially reduced. In addition, it becomes feasible to provide laser light sources capable of eliminating, or hardly resulting, the emergence of interference of the light beams even after slight changes in spatial coherence characteristics caused, for example, by the fluctuation of laser source conditions.

Still in addition, by providing the polarization conversion unit having the construction disclosed in the abovementioned the second and third embodiments, the emergence of finer interference patterns can be suppressed for the light beams each passing through dividing regions with the larger period than the twofold, such as threefold and fourfold period, which has not been feasible previously.

Namely, by suitably making the arrangement of wave plates and the adjustment of the direction of optical axis of the plates according to an embodiment, it becomes feasible to control spatial frequency components of interference pattern, which are remained even after suitable adjustments of spatial coherence lengths of laser source, and of pitches for dividing regions in wavefront dividing unit.

Therefore, the arrangement of the wave plates and the direction of optical axis of the plates may suitably be adjusted depending on application purposes of varieties optical systems incorporating the laser light source of the embodiment.

### FOURTH EMBODIMENT

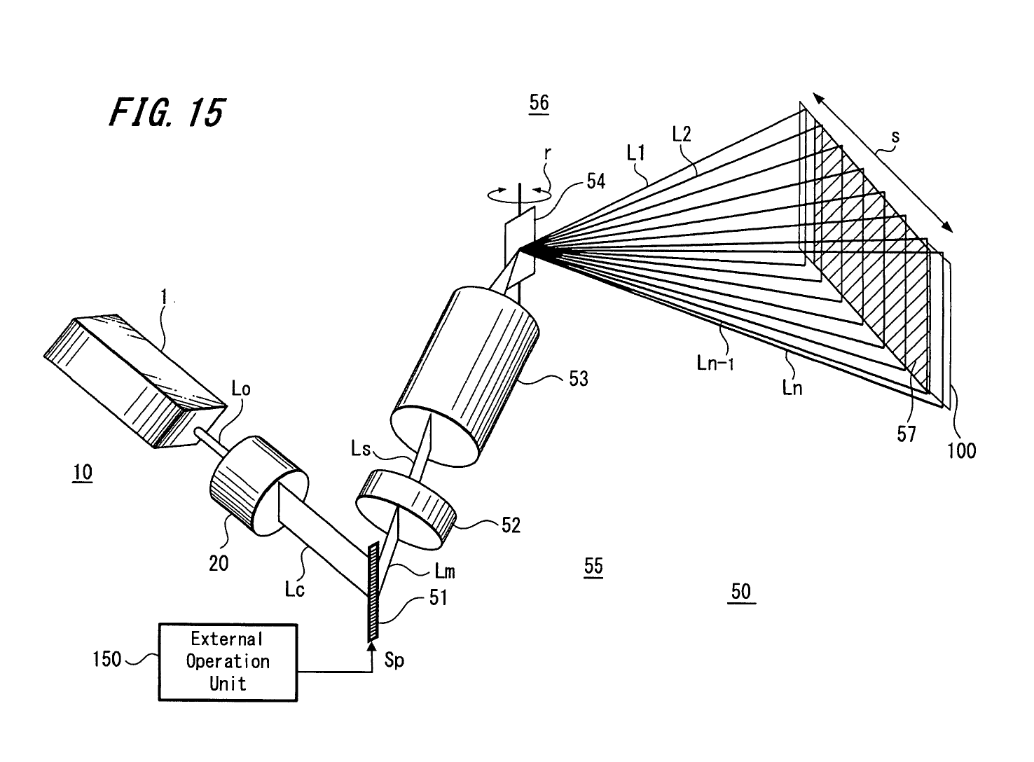

An image forming apparatus is disclosed incorporating the abovementioned laser light source units in reference to FIGS. 15 through 19.

FIG. 15 is a perspective view illustrating the image forming apparatus 50 according to a fourth embodiment.

Referring to FIG. 15, the image forming apparatus 50, for example, includes the laser light source unit 10 including the light source 1 and an illuminating optical system 20 including the aforementioned wavefront dividing and wavefront synthesizing units, a light modulation unit 55 including a diffraction grating type one-dimensional light modulation section 51, for example, and a light selecting section 52, and a scanning optics unit 56 including a projection optical section 53 and a scanning element 54.

The light source 1 may suitably includes, for example, an array laser formed of linearly arranged multiple semiconductor laser elements, and a bar laser of multiple laser elements formed integrally, and other similar elements. In addition, the light source 1 may alternatively includes other light sources such as solid-state laser emission generated by one-dimensional multi-transversal mode oscillation, and the one-dimensional emission generated from the above emission by wavelength conversion using non-linear optical elements which are provided in either the exterior or interior of resonators of the solid-state laser.

The light Lo, which is emitted from the light source 1 of the laser light source equipment 10 in the present construction, is subsequently output as a laser light with reduced interference patterns to have a predetermined beam shape of one-dimensional (linear) in the present case, for example, by means of the illuminating optical system 20 including the aforementioned wavefront dividing, and wavefront synthesizing units (not shown); and subsequently illuminates the diffraction grating type one-dimensional light modulation section 51 as a one-dimensional (linear) beam.

The diffraction grating type light modulation section 51 is configured to operate based on the signals Sp received from a drive circuit (not shown). In the use of the diffraction grating type structure for the light modulation section 51, the beams diffracted therefrom are incident on the light selecting section 52.

It may be noted regarding the optical units when light beams of three primary colors are in use, an alternative construction may be adopted. For example, the optical unit may be configured such that the light beams are led from the light source of respective color; by way of one-dimensional illuminating optical system and light modulation section, for respective color, to a color synthesizing unit including a conventional L-shaped prism and others, for example, to be superposed between colors, and subsequently output to the light selecting section 52.

The light selecting section 52 employs the Offner relay optical system, and a spatial filter such as Schlieren filter and other similar elements (not shown), which is configured to select the plus (+) first-order beams and output these beams as a one-dimensional image light Lm. The image light Lm is then magnified through the projection optical section 53, and subjected to scanning in such a manner shown as L1, L2 . . . Ln−1, Ln through the rotation indicated with the double-headed arrow r by means of a scanning element 54 included in the scanning optics unit 56, thereby forming a two-dimensional image 57 on an imaging plane 100.

As the scanning element 54, a galvanometer mirror and a polygonal mirror are suitably used. In addition, the so-called resonant scanner may alternatively be used, which is configured to perform scanning operation through resonance movements activated by an electromagnet, for example.

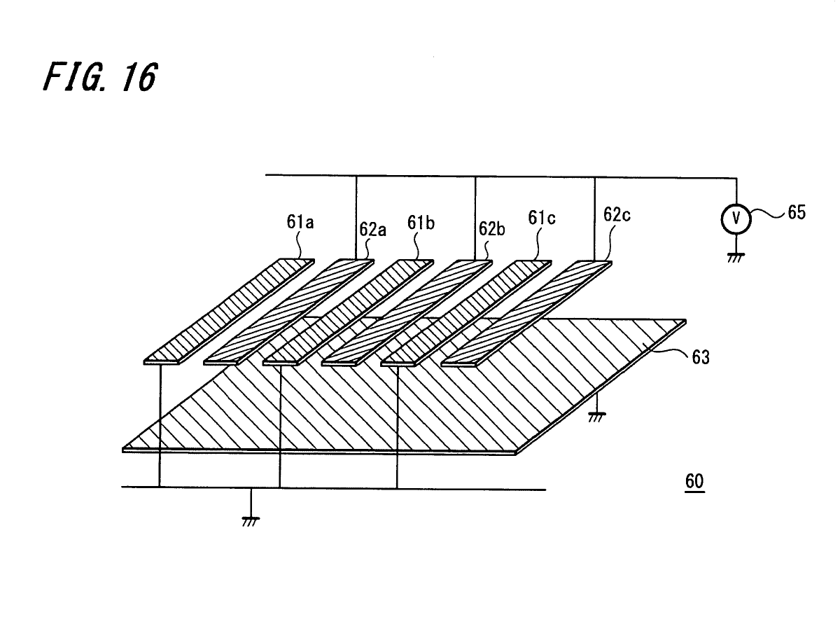

In the next place, an example of the one-dimensional light modulation section is described in reference to FIGS. 16 through 18, which can suitably be used in the above-mentioned image forming apparatus.

FIG. 16 is a perspective view diagrammatically illustrating major components of a light modulation element included in the one-dimensional light modulation section according to the fourth embodiment. Referring to FIG. 16, the light modulation element 60 is formed including a substrate including silicon, for example; a common electrode 63 of a polysilicon film formed on the substrate; and first electrodes 61a to 61c and second electrodes 62a to 62c provided alternately, each formed as a stripe, the top face thereof covered with reflecting layer, and having a predetermined spacing between the common electrode 63.

The first electrodes 61a to 61c are subjected to be at a fixed potential such as ground, for example, while the second electrodes 62a to 62c are formed as movable electrodes or flexible portions connected to a driving voltage source 65.

In such a construction of the light modulation element, the first electrodes 61a to 61c are fixed with the same height of reflecting layers throughout the first electrodes. By contrast, the second electrodes 62a to 62c are movable or flexible relative to the common electrode 63 by either attractive or repulsive force caused by the electrostatic interaction depending on driving voltages, and the height (or, distance from the substrate) of reflecting layers can therefore be changed.

As a result of the displacement or flection of second electrodes 62a to 62c the light modulation element is capable of functioning as a diffraction grating with constant pitch and adjustable depth.

The light modulation element 60 is illustrated hereinabove to be provided, per pixel in the light modulation section, with six electrodes such as the first and second electrodes 61a to 61c and 62a to 62c, and operated to perform the modulation in response to image signals of one pixel. However, it may be noted that the number of electrodes on the first and second electrodes 61a to 61c and 62a to 62c, is not limited to six as shown in FIG. 16, but other numbers such as two, four and others may suitably be adopted.

In addition, the structure of the light modulation section is completed by providing as a large number of light modulation elements as the number to correspond to pixels in parallel to be aligned to the direction orthogonal to the longitudinal side of the electrodes. Namely, the total of the electrodes provided in the light modulation section may suitably be determined depending on the number of electrodes per pixel and the number of pixels of intended display images.

Regarding the size of the light modulation elements 60, the first and second electrodes are each formed typically ranging from 3 to 4 mμ in width, and 200 to 40 mμ in length, and approximately 0.6 mμ in spacing therebetween. This results in the width of approximately 25 mμ for the six electrodes for the abovementioned one pixel.

In the one-dimensional light modulation sections currently nearing practical use intending to display 1080 pixels, there are provided in parallel so a large number of electrodes as to correspond to the 1080 pixels.

As to the diffraction grating type light modulation section, there proposed are typically two types, the one of the ordinary type with the electrodes being provided in plane and operating approximately in plane, and the other of the so called blaze type with the electrodes each provided as inclined plane having a predetermined angle with respect to reference plane (e.g., substrate surface of modulation section).

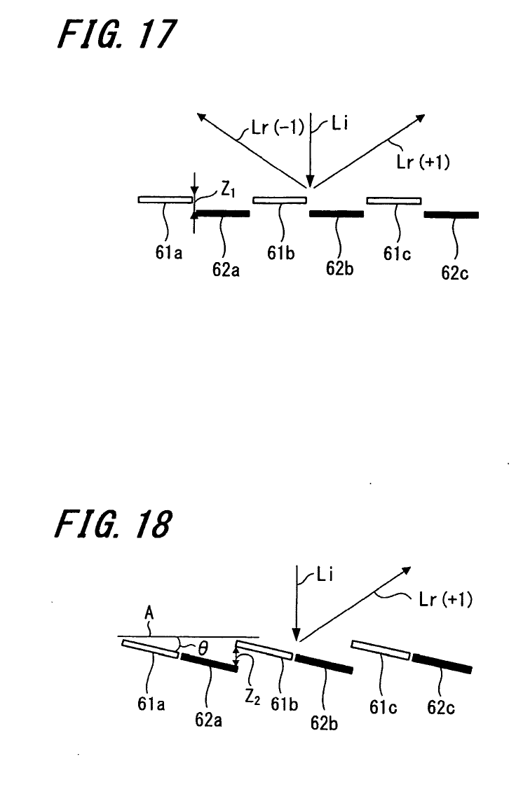

The light modulation sections of these two types are illustrated sectionally in FIGS. 17 and 18, respectively. The components included in FIGS. 17 and 18 similar to those in FIGS. 4 and 6 are shown with identical numerical representations and the repeated description thereof is herewith abbreviated.

Although the light modulation element 60 is illustrated being provided with six electrodes per pixel in total, that is, three for each of the first and second electrodes, it may be noted that the number of electrodes is not limited to that number and other numbers may suitably be adopted.

Referring to FIG. 17 for illustrating the ordinary type light modulation section operational, in the case where the electrical bias results in the amount of displacement Z1 to be a quarter wavelength of the incident light, λ/4, the height difference caused by the displacement produces diffracted light including plus one (+1) and minus one (−1) diffraction orders, Lr (+1) and Lr (−1), in addition to 0 (zero) order diffracted light (not shown) reflected in the direction opposite to the incidence. For the wavelength λ=532 mμ for example, the amount of displacement Z1 is obtained to be λ/4=133 mμ.

In the case where only the plus one (+1) order diffracted light is utilized, an image can be formed on a screen after putting one diffracted light beam alone through a spatial filter. During non-operating periods (with zero driving voltage applied), no plus one (+1) order diffracted light is produced, and this off-state corresponds to the dark state on the display, thus resulting the black display screen. Namely, by suitably adjusting the driving voltage to the second electrodes 62a to 62c applied from the exterior in response to image signals, and thereby controlling the amount of displacement Z1, various display steps become feasible to correspond to on/off state of pixels and the gradation between these states.

On the other hand, in reference to FIG. 17 for illustrating the blaze type light modulation section, the electrodes 61a to 61c and 62a to 62c, are each provided inclining with a predetermined angle θ, for example, with respect to base plane A or the plane parallel to the surface of the substrate (not shown) of light modulation section. The angle θ is determined preferably to produce the height difference of one quarter of the wavelength of the incident light, λ/4, between neighboring electrodes. The second electrodes 62a to 62c are displaced during the operation for each of the first and second electrode pairs, 61a and 62a, 61b and 62b, and 61c and 62c, to align in plane.

During the operation of this type of the light modulation section, the plus one (+1) order diffracted light alone is emitted by driving the second electrodes 62a to 62c to achieve the height difference of λ/4 (i.e., the λ/2 height difference between the adjacent electrode pairs). Therefore, by utilizing the (+1) order diffracted light, an image can be formed on a screen after putting one diffracted light beam alone through a spatial filter. Namely, in the case where the blaze type light modulation section is used, the light utility value increases with the configuration of utilizing one diffracted light beam among a large number of reflected diffraction beams

By means of the image forming apparatus of the embodiment, which is constructed incorporating the one-dimensional light modulation section and laser light source unit mentioned hereinabove as shown in FIG. 15, the one-dimensional light modulation section becomes capable of receiving light beams with improved uniformity in intensity distribution after suitable division and superposition of the wavefront, and preventing the emergence of interference patterns.

As a result, it becomes feasible for the image forming apparatus to carry out excellent light modulation, prevent undue deterioration of image quality otherwise caused by the interference patterns, and form excellent images without loss of the light utility value.

It may be noted that the construction of image forming apparatus is not limited to the fourth embodiment. For example, beside the use of laser light source unit described earlier, it is appreciated that various changes and modifications may be made to the light modulation unit, projection optical section, and scanning optics unit. In addition, the image forming apparatus may also be employed in the area other than the above-mentioned image projection display, such as a laser printer for generating character information and images, for example.

Still in addition, it is understood that the configuration according to the embodiment is not limited to the embodiments disclosed hereinabove. For example, in regard to the number of components and materials construction of the wavefront synthesizing unit and other units included in laser light source unit, a variety of changes and modifications may be implemented.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A laser light source unit, comprising:
a light source;
a wavefront dividing unit including at least a plurality of dividing regions configured to divide a first wavefront of light emitted from the light source to form a plurality of light beams;
a wavefront synthesizing unit configured to synthesize the first wavefront of light divided by the wavefront dividing unit to form a second wavefront and lead the second wavefront to a subject to be illuminated; and
a polarization conversion unit configured to rotate a plane of polarization of a portion of the plurality of light beams, wherein
the polarization conversion unit includes at least a plurality of wave plates each having a direction of optical axis different each other.

2. A laser light source unit according to claim 1, wherein the plurality of wave plates include first and second wave plates, the first wave plate being configured to rotate the plane of polarization approximately by 90 degrees in negative sense, and the second wave plate being configured to rotate the plane approximately by 90 degrees in positive sense.

3. A laser light source unit according to claim 2, wherein the first and second wave plates are alternately provided respectively facing to every other dividing region of the plurality of dividing regions included in the wavefront dividing unit.

4. A laser light source unit according to claim 2,
wherein a first pair of the first and second wave plates is provided facing two neighboring dividing regions of wavefront dividing unit and a second pair of the first and second wave plates similar to the first pair is provided respectively facing fifth and sixth dividing regions with two dividing regions interposed therebetween, and wherein
an arrangement with the first and second pairs is repeated continuously in that order.

5. A laser light source unit according to claim 2, wherein
a first pair of the first and second wave plates is provided facing two neighboring dividing regions of wavefront dividing unit and a second pair of the second and first wave plates in place of the first and second wave plates is provided facing fifth and sixth dividing regions with two dividing regions interposed therebetween, and wherein
an arrangement with the first and second pairs is repeated continuously in that order.

6. A laser light source unit according to claim 1, wherein
the wavefront dividing unit includes at least one cylindrical lens array, and wherein
the dividing region is one of the lens cells included in the cylindrical lens array.

7. A laser light source unit according to claim 1, wherein the polarization conversion unit is placed either one of two locations, one being just in front of, and an other being right behind, a last optical element along a direction of light propagation.

8. A laser light source unit according to claim 1, wherein the light source is provided with a plurality of laser elements aligned in-line configured to emit laser light one-dimensionally.

9. An image forming apparatus, comprising:
a laser light source unit;
a light modulation unit;
a projection optical section; and
a scanning optics unit, wherein
the laser light source unit includes at least a light source, a wavefront dividing unit configured to divide a first wavefront of light emitted from the light source to form a plurality of light beams, a wavefront synthesizing unit configured to synthesize the first wavefront of light divided by the wavefront dividing unit to form a second wavefront and lead the second wavefront to a subject to be illuminated, and a polarization conversion unit configured to rotate a plane polarization of a portion of the plurality of light beams, and wherein
the polarization conversion unit includes at least a plurality of wave plates each having a direction of optical axis different each other.

10. An image forming apparatus according to claim 8, wherein
the light source included in the laser light source unit is provided with a plurality of laser elements aligned in-line configured to emit laser light one-dimensionally, and wherein
the light modulation unit is formed as a one-dimensional light modulation unit.

11. An image forming apparatus according to claim 8, wherein
the light source included in the laser light source unit is configured to emit a one-dimensional emission as one of a solid-state laser emission generated by one-dimensional multi-transversal mode oscillation and a one-dimensional emission generated from the solid-state laser emission by wavelength conversion using non-linear optical elements, and wherein
the light modulation unit is formed as a one-dimensional light modulation unit.
